(19) United States
(12) Patent Application Publication
(10) Pub. No.: US 2021/0189085 A1
(43) Pub. Date: Jun. 24, 2021

(54) Polyolefin Polymers With Increased Melt Strength

(71) Applicant: W. R. Grace & Co.-CONN, Columbia, MD (US)

(72) Inventors: Amaia Montoya, Columbia, MD (US); Jing Zhong, Columbia, MD (US)

(21) Appl. No.: 16/754,794

(22) PCT Filed: Oct. 26, 2018
(86) PCT No.: PCT/US2018/057644

§ 371 Date: Apr. 9, 2020

Related U.S. Application Data
(60) Provisional application No. 62/578,162, filed on Oct. 27, 2017.

(51) Int. Cl. C08J 9/14; C08K 5/1575; C08F 110/06; C08J 9/12; C08J 9/10; C08J 9/08; C08J 9/00

(52) U.S. Cl. CPC C08J 9/148; C08K 5/1575; C08F 110/06; C08J 9/144; C08J 9/141; C08J 9/122; C08J 2323/12; C08J 9/106; C08J 9/105; C08J 9/103; C08J 9/08; C08J 9/0023; C08J 9/107

(57) ABSTRACT

A polymer composition with increased melt strength is disclosed. The polymer composition contains at least one polypropylene polymer combined with at least one melt strength modifier. The melt strength modifier can comprise a sorbitol derivative in an amount sufficient to change the melt strength characteristics and properties of the polymer. The polymer composition can be used in thermoforming processes and to produce polymer foams. The melt strength modifier can increase the melt strength of the polymer without having to induce branching in the polypropylene polymer.

### RELATED APPLICATIONS

The present application is based on and claims priority to U.S. Provisional Patent Application Ser. No. 62/578,162 having a filing date of Oct. 27, 2017, which is incorporated herein by reference in its entirety.

### BACKGROUND

Polyolefin polymers are used in numerous and diverse applications. Polyolefin polymers, such as polypropylene, for instance, are semi-crystalline polymers having good chemical resistance, good heat resistance, and good fatigue resistance. Polypropylene is also relatively tough and has excellent thermoplastic properties allowing the polymers to be made into numerous and diverse shapes.

In some specific applications, such as thermoforming and foaming processes, high melt strength is generally required. High melt strength is needed, for instance, in order to thermoform the composition into a desired shape or in order to form foam cells. During thermoforming processes, for instance, the polymer is heated above a specific temperature and then shaped into a desired object. When formed into an object having a complex shape, when forming thick gauge, large parts a high melt strength is needed in order to maintain shape stability as well as stretchability during the forming process. The polymer, for instance, should be capable of maintaining sufficient structural integrity during the aforementioned process and until the article is solidified

Similarly, high melt strength is also needed during thermal foaming processes. Without sufficient melt strength, the thin cell walls can collapse or otherwise form a foam with less than desired physical properties.

In the past, various methods and techniques have been used in order to increase the melt strength of polypropylene polymers. For instance, one method to increase melt strength is to create long chain branches on the polypropylene polymer. Polypropylene polymers having long chain branches can be produced using in-reactor methods and post-reactor methods. For in-reactor methods, special catalysts are needed in order to induce macromer polymerization. In-reactor processes are not only prohibitively expensive, but also produce low yields.

Post-reactor methods for creating long chain branched polypropylene polymers include exposing the polymer to electron beam or gamma radiation. The high energy radiation induces chain scission and polymer radicals which finally recombine to form long chain branching under low/zero oxygen environment. Unfortunately, however, exposure to electron beams creates post-radiation degradation. In addition, the radiation still requires further processing of the polymers and therefore leads to increased cost.

Post reaction of polypropylene in the presence of co-agents or polyfunctional monomers is also an option to create long chain branching in polypropylene. However, similar to the radiation method, cost and low productivity have set limitations on further commercialization.

Another way to increase the melt strength of polypropylene is to broaden the molecular weight distribution. However, the melt strength through this method is limited compared to polypropylene with long chain branches.

In view of the above, a need exists for a method of increasing the melt strength of a polypropylene polymer without having to create long chain branches within the polymer. A need also exists for a polypropylene polymer composition having increased melt strength that can be used during thermoforming processes and during foaming processes.

### SUMMARY

In general, the present disclosure is directed to a polymer composition containing a propylene-based polymer having enhanced melt strength. In accordance with the present disclosure, a melt strength modifier is combined with a polypropylene polymer in an amount sufficient to increase the melt strength of the polymer. For instance, the melt strength modifier is blended with the polymer in an amount sufficient for the polymer to maintain a gel-like network at higher temperatures while the polymer is in a molten state. The gel-like network increases the elasticity and dramatically increases melt strength.

For example, in one embodiment, the present disclosure is directed to a polymer composition with increased melt strength. The polymer composition includes a polypropylene polymer that comprises at least 60 mol percent propylene. The polypropylene polymer, for instance, can comprise a polypropylene homopolymer, a polypropylene copolymer, or mixtures thereof.

In accordance with the present disclosure, the polymer composition further contains a melt strength modifier present in the polymer composition sufficient for the polymer composition to form a penetration network when the polymer composition is in a molten state. As used herein, a penetration network is a physical, solid-like three-dimensional network throughout the polymer matrix. The network may be formed via covalently or physically bonded molecular structures. In one embodiment, the polymer network is formed within only a single polymer and may include entangled polymer chains.

In one embodiment, the melt strength modifier is present in the polymer composition such that the polymer composition has a viscoelastic transition temperature of greater than about 180° C., such as greater than about 185° C.

The polymer composition of the present disclosure can also have various physical properties. For instance, the polymer composition can have a strain hardening index of greater than about 0.4.

In addition to having a strain hardening index of greater than about 0.4, in one embodiment, the polymer composition can also have a shear thinning factor of greater than about 50, such as greater than about 60, such as greater than about 70, such as greater than about 80. The shear thinning factor is generally less than about 300. In addition, the polymer composition can have an elastic index of greater than about 0.2.

In one embodiment, the melt strength modifier may comprise a benzylidene sorbitol derivative. Examples of melt strength modifiers, for instance, include 1,3:2,4-bis(3,4-dimethyldibenzylidene)sorbitol, 1,2,3-tridesoxy-4,6:5,7-bis-O-[(4-propylphenyl)methylene]nonitol, 1,3:2,4-bis(p-nitrobenzylidene)sorbitol, (1,3-2,4-dibenzylidenesorbitol), 1,3-2,4-bis(p-methoxybenzylidene)sorbitol, 1,3:2,4-bis(m-methoxybenzylidene)sorbitol, 1,3:2,4-bis(p-chlorobenzylidene)sorbitol, 1,3:2,4-bis(p-methylbenzylidene)sorbitol, or mixtures thereof. The melt strength modifier, in one embodiment, can be present in the polymer composition in an amount generally greater than about 0.6% by weight, such as in an amount greater than about 0.8% by weight, such as in an amount greater than about 1% by weight, such as in an amount greater than about 1.2% by weight, such as in an amount greater than about 1.4% by weight, such as in an amount greater than about 1.6% by weight, such as in an amount greater than about 1.8% by weight, such as in an amount greater than about 2% by weight. The melt strength modifier is generally present in the polymer composition in an amount less than about 10% by weight, such as in an amount less than about 5% by weight, such as in an amount less than about 4% by weight.

Of particular advantage, the polymer composition of the present disclosure can have the above described melt strength properties without having to use a polypropylene polymer having long chain branches. In this regard, in one embodiment, a linear polypropylene polymer may be used to form the composition.

In one embodiment, the polymer composition can be formulated to form a polypropylene foam. For instance, the polymer composition can contain a nucleating agent and a blowing agent. The blowing agent can comprise, for instance, nitrogen, carbon dioxide, isobutane, cyclopentane, air, methyl chloride, ethyl chloride, pentane, isopentane, perfluoromethane, chlorotrifluoromethane, dichlorodifluoromethane, trichlorofluoromethane, perfluoroethane, 1-chloro-1,1-difluoroethane, chloropentafluoro-ethane, dichlorotetrafluoroethane, trichlorotrifluoroethane, perfluoropropane, chlorohepta-fluoropropane, dichlorohexafluoropropane, perfluorobutane, chlorononafluorobutane, perfluorocyclobutane, azodicarbonamide (ADCA), azodiisobutyronitrile, benzenesulfon-hydrazide, 4,4-oxybenzene sulfonyl-semicarbazide, p-toluene sulfonyl semicarbazide, barium azodicarboxylate, N,N′dimethyl-N,N′-dinitrosoterephthalamide, trihydrazino triazine, N,N-dinitroso pentamethylene, citric acid derivative, tetramine, 5-phenyltetrazole, hydrazo dicarbonamide, p-toluene sulfonyl hydrazide, or mixtures thereof.

In this regard, the present disclosure is also directed to a process for forming a polypropylene foam. The process includes the step of combining the polypropylene composition as described above containing the melt strength modifying agent and combining the polymer composition with a blowing agent and a nucleating agent. The polymer composition is heated to a molten state sufficient for the blowing agent to induce formation of foam cells.

For example, in one embodiment, the propylene-based polymer composition can be heated to a molten condition. A blowing agent can be incorporated into the composition in order to form a dispersion of the gaseous material in the polymer composition while in the molten state. The molten polymer composition is then allowed to generate a foamed structure. The foamed structure can be molded into a desired shape without collapsing the foam structure. For instance, the foamed article can be a disposable drinking cup.

The present disclosure is also directed to a process for thermoforming a polypropylene polymer. The process includes blending a polypropylene polymer with a melt strength modifier as described above. The polymer composition is heated into a molten state sufficient to form the polymer into an article during a thermoforming process. For instance, the polymer article can comprise articles used in food packaging, disposable articles such as drinking cups, parts of large appliances such as fridge inner liners, automotive parts such as recreational vehicle panels, and the like.

The present disclosure is also directed to a method for increasing the melt strength of a polypropylene polymer. The method includes the step of blending a polypropylene polymer with a melt strength modifier as described above.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying FIGURES, in which:

FIG. 1 is a graphical representation of some of the results obtained in the example below.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to polymer compositions containing a polyolefin polymer, such as a polypropylene polymer, that has increased melt strength. The present disclosure is also directed to various methods and processes for forming polymer articles, including foam articles from the polymer composition.

In one embodiment, the polymer composition of the present disclosure contains one or more polypropylene polymers combined with a melt strength modifier. The melt strength modifier is added to the polymer composition in an amount sufficient to increase the elasticity of the polymer composition at elevated temperatures, such as at temperatures where the polymer composition is in a molten state. For example, in one embodiment, the melt strength modifier may comprise a gelling agent that maintains a gel-like network at higher temperatures. The melt strength modifier can also be added in amounts insufficient to increase the viscosity of the polymer composition in an amount that renders the molten polymer unsuitable for molding applications. By increasing the elasticity of the polymer composition at elevated temperatures, the melt strength of the polymer composition is dramatically increased thus allowing the polymer composition to be thermoformed into all different shapes and also allowing the polymer composition to form a foam with closed cells.

In one embodiment, the melt strength modifier is present in the polymer composition in an amount sufficient to create a penetration network as described above.

In one embodiment, the melt strength modifier may comprise a sorbitol derivative. In the past, specific sorbitol derivatives have been combined with polyolefin polymers in order to act as a nucleating agent or as a clarifying agent. In these applications, the sorbitol derivative was added at relatively minor amounts. According to the present disclosure, however, the sorbitol derivative is added to the polymer in an amount sufficient to modify and increase the melt strength such that the polymer composition at elevated temperature has a particular combination of properties found well suited during thermoforming molding processes and/or foaming processes. In fact, in some embodiments, the clarity of the resulting polymer may actually be adversely affected.

In order to define polymer compositions made in accordance with the present disclosure, various different tests are conducted on the polymer compositions that are related to the melt strength of the polymer. The following is a description of the various tests:

### Shear Thinning Factor (STF)

The shear thinning factor is a ratio of the viscosity of the polymer composition at low shear and at high shear. Rheological measurements are carried out using an advanced rheometric expansion system (ARES-G2) with a separate motor and transducer. The complex viscosity of the polymer composition is measured by a frequency sweep from 350 to 0.1 at 190° C. The strain amplitude is 2% which is verified to be in the linear viscoelastic region. The polymer in the form of pellets can be compressed to a disk with a 25 mm diameter and a 2 mm thickness. Carreau-Yasuda model is applied to fit the zero sheer viscosity. The shear thinning factor (STF) is defined as the ratio of the zero shear viscosity and viscosity at G*=100 kPa according to the following equation:

$$STF = \frac{{η}_{0}}{\text{?}}$$

$$\text{?} \text{indicates text missing or illegible when filed}$$

### Polydispersity Index

PDI was calculated using Equation PDI= [symbol] 10) [symbol] \hat{ }5/Gx, where Gx is the crossover modulus of G′ and G″ so Gx=G′=G″. G′ and G″ are storage and loss modulus obtained by the frequency sweep described above.

### Viscoelastic Transition Temperature

The viscoelastic transition temperature is the temperature at which a viscosity jump occurs when the viscosity is plotted versus the temperature. The viscosity transition temperature is measured by a temperature sweep using the ARES-G2 system. The viscosity is measured from 170° C. to 250° C. by a 3° C./min under a frequency of 1 rad/s (250° C. to 150° C.). The peak temperature of the first derivative curve of viscosity versus temperature is treated as the transition temperature.

### Strain Hardening Index

The strain hardening index is a measurement of the extensional viscosity of the composition. The extensional viscosity is measured using an extensional viscosity fixture (EVF) in the ARES-G2 system. The polymer composition, which may be in the form of pellets, can be compressed to a sheet with dimensions of 18 mm×10 mm×0.7 mm. An extensional rate of 1 s⁻¹ is applied. The sample is isothermal for 5 mins. at 190° C. then the extensional viscosity is measured at 145/155/160° C. The strain hardening index is defined as the chord slope between the viscosity at a Hencky strain of 1 and 3 in a logarithm to the basis of 10 scale. The strain hardening index is calculated according to the following equation:

$$SHI = \frac{log ( {η}_{ɛ} ( ɛ = 1 ) ) - log ( {η}_{ɛ} ( ɛ = 3 ) )}{log ( 3 ) - log ( 1 )}$$

### Elastic Index

Creep and recovery measurements were obtained using a rheometric system AR-G2 combined with a motor and transducer. A constant stress of 50 Pa is applied over a creep time of 300 seconds. The stress is removed to let the sample recover for 600 seconds. The recovery compliance at 600 seconds is defined as the equilibrium compliance. The elasticity index was calculated as follows:

$$EI = \text{?} ( t = 600 s ) / \text{?} ( t = 300 s )$$

$$\text{?} \text{indicates text missing or illegible when filed}$$

The polymer composition of the present disclosure can be defined by one or more of the above properties and characteristics.

The polymer composition can generally have a shear thinning factor of greater than about 50, such as greater than about 55, such as greater than about 60, such as greater than about 65, such as greater than about 70, such as greater than about 75, such as greater than about 80, such as greater than about 85, such as greater than about 90, such as greater than about 95, such as greater than about 100. The shear thinning factor is generally less than about 500, such as less than about 400, such as less than about 300, such as less than about 200, such as less than about 100.

The strain hardening index of the polymer composition is generally greater than about 0.4, such as greater than about 0.8, such as greater than about 1, such as greater than about 1.2, such as greater than about 1.4, such as greater than about 1.6, such as greater than about 1.8, such as greater than about 2. The strain hardening index is generally less than about 5, such as less than about 4, such as less than about 3.

The elastic index of the polymer composition based on the creep characteristics of the composition is generally greater than about 0.2, such as greater than about 0.4, such as greater than about 0.6 and generally less than about 0.8, such as less than about 0.7.

The viscoelastic transition temperature of the polymer composition is generally greater than about 180° C., such as greater than about 190° C., such as greater than about 200° C., such as greater than about 210° C. The viscoelastic transition temperature is generally less than about 240° C., such as less than about 230° C., such as less than about 220° C.

As described above, the polymer composition of the present disclosure generally contains one or more polypropylene polymers in combination with one or more melt strength modifiers. Propylene-based polymers that may be used in the present disclosure include for example propylene homopolymers. Alternatively, the propylene-based polymer may be a propylene copolymer. Such propylene copolymer may be a propylene random copolymer. Alternatively, such propylene copolymer may be a heterophasic propylene polymer.

In one embodiment, for instance, the polymer composition of the present disclosure contains a polypropylene homopolymer. The polypropylene homopolymer can be present in the polymer composition in an amount greater than about 40% by weight, such as in an amount greater than about 50% by weight, such as in an amount greater than about 60% by weight, such as in an amount greater than about 70% by weight, such as in an amount greater than about 80% by weight, such as in an amount greater than about 90% by weight.

In one embodiment, the polymer composition may contain a polypropylene homopolymer in combination with a propylene-α-olefin copolymer or may only contain a propylene-α-olefin copolymer. The propylene-α-olefin copolymer comprises units derived from propylene and one or more alpha-olefin comonomers. Exemplary comonomers utilized to manufacture the propylene/alpha-olefin copolymer are C₂ and C₄ to C₁₀ alpha-olefins; for example, C₂, C₄, C₆ and C₈ alpha-olefins.

In still another embodiment, the polymer composition may contain a heterophasic propylene polymer composition. The heterophasic propylene polymer may for example comprise a matrix phase and at least one dispersed phase. The matrix phase of the heterophasic propylene polymer may for example comprise a propylene polymer such as a propylene homopolymer or a propylene-based copolymer. The matrix phase may for example comprise a propylene homopolymer. The propylene-based copolymer may for example be a copolymer of propylene and an α-olefin comonomer.

The dispersed phase of the heterophasic propylene copolymer may for example comprise an ethylene-propylene elastomer. The ethylene-propylene elastomer may for example comprise ≥10.0% and ≤65.0% by weight, alternatively ≥20.0% and ≤50.0% by weight of polymeric units derived from ethylene, with regard to the total weight of the ethylene-propylene elastomer. The dispersed phase may for example be present in an amount of ≥5.0% and ≤40.0% by weight, alternatively ≥15.0% and ≤35.0% by weight, with regard to the total weight of the heterophasic propylene copolymer.

The propylene-based polymer may be produced via any process for the production of propylene-based polymers known in the art. Such processes may for example include one or more of gas-phase polymerisation processes, slurry-phase polymerisation processes, and solution polymerisation processes. Such processes may for example be catalytic polymerisation processes. Such catalytic polymerisation processes may for example be performed in the presence of one or more of a Ziegler-Natty type catalyst, a single-site type catalyst such as a metallocene-type catalyst, or any other type of catalyst known in the art of production of propylene-based polymers. Such processes may for example involve a single polymerisation stage or alternatively multiple polymerisation stages. Such process involving multiple polymerisation stages may for example involve multiple polymerisation stages in series. Such multiple polymerisation stages may be performed in a single polymerisation reactor or in multiple polymerisation reactors. Such multiple stage polymerisation process may for example comprise one or more gas-phase polymerisation reactor, one or more slurry-phase polymerisation reactor, and/or one or more solution polymerisation reactor, or any combination of such reactors in any order.

As described above, one or more polypropylene polymers are combined with a melt strength modifier in accordance with the present disclosure. The melt strength modifier, for instance, can comprise a sorbitol derivative added to the polymer composition in an amount sufficient to increase melt strength. In general, any suitable sorbitol derivative capable of increasing melt strength may be used in accordance with the present disclosure. In one embodiment, for instance, the sorbitol derivative may comprise a dibenzylidene sorbitol derivative or a sorbitol acetate.

Examples of sorbitol derivatives that may be used in accordance with the present disclosure include 1,3:2,4-bis(3,4-dimethyldibenzylidene)sorbitol; 1,2,3-tridesoxy-4,6:5,7-bis-O-[(4-propylphenyl)methylene]nonitol; 1,3:2,4-bis(p-nitrobenzylidene)sorbitol; (1,3:2,4-dibenzylidenesorbitol); 1,3:2,4-bis(p-methoxybenzylidene)sorbitol; 1,3:2,4-bis(m-methoxybenzylidene)sorbitol; 1,3:2,4-bis(p-chlorobenzylidene)sorbitol; 1,3:2,4-bis(p-methylbenzylidene)sorbitol; 1,3:(4-tolylidene)-2,4-(2-thiophenylidene)-D-sorbitol; 1,3-(p-methylthiobenzylidene)-2,4-(p-tolylidene)-D-sorbitol; 1,3-(p-n-butylbenzylidene)-2,4-(p-tolylidene)-D-sorbitol; 1,3:2,4-di-(2-naphthylidene)-D-sorbitol or mixtures thereof.

In one embodiment, the sorbitol derivative may comprise a disubstituted dibenzylidene sorbitol derivative having an allyl group or a n-propyl group substituted on the first carbon of the sorbitol chain (C-1 position). The sorbitol compounds may be represented by formula I:

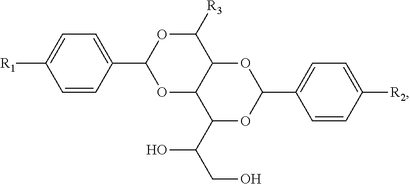

wherein R₁ and R₂ are independently selected from the group consisting of: CH₃CH₂CH₂— (i.e. n-propyl) and CH₃CH₂CH₂O— (i.e. n-propoxy); and wherein R₃ is independently selected from the group consisting of: —CH₂CH₂CH₃ (n-propyl) and —CH₂—CH═CH₂ (allyl).

In one embodiment, the compound of formula I is provided, wherein R₃ is a n-propyl group (—CH₂CH₂CH₃). In an alternative embodiment, R₃ is an allyl group (—CH₂CH═CH₂).

In one embodiment, R₁ and R₂ are n-propyl. In alternate embodiment, R₁ and R₂ are n-propoxy.

In another embodiment, R₁ and R₂ are the same; that is, the compound of formula I is symmetric. In another embodiment, R₁ and R₂ are different; that is, the compound of formula I is asymmetric.

In another embodiment, R₃ is allyl and R₁ and R₂ are independently selected from the group consisting of n-propyl and n-propoxy.

In another embodiment, R₃ is n-propyl and R₁ and R₂ are independently selected from the group consisting of n-propyl and n-propoxy.

According to one embodiment, the compound of formula I is as follows:

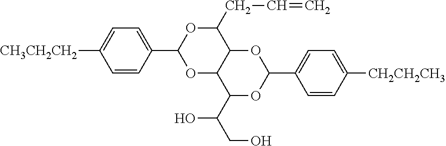

According to another embodiment, the compound of formula I is as follows:

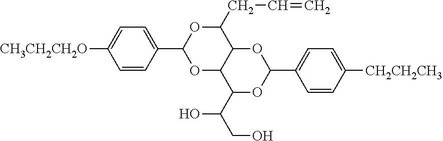

According to another embodiment, the compound of formula I is as follows:

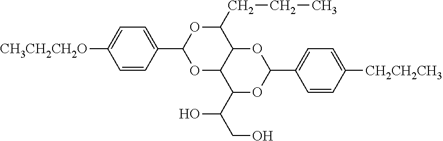

According to another embodiment, the compound of formula I is as follows:

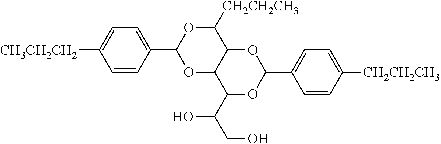

One or more melt strength modifiers are present in the polymer composition in an amount sufficient to achieve desired melt strength as may be measured according to the shear thinning factor, the viscosity transition temperature, the strain hardening index, the elasticity index, or mixtures thereof. In general, one or more melt strength modifiers are present in the polymer composition in an amount greater than about 0.6% by weight, such as in an amount greater than about 0.8% by weight, such as in an amount greater than about 1% by weight, such as in an amount greater than about 1.2% by weight, such as in an amount greater than about 1.4% by weight, such as in an amount greater than about 1.6% by weight, such as in an amount greater than about 1.8% by weight, such as in an amount greater than about 2% by weight, such as in an amount greater than about 2.2% by weight, such as in an amount greater than about 2.4% by weight, such as in an amount greater than about 2.6% by weight. One or more melt strength modifiers are generally present in the polymer composition in an amount less than about 10% by weight, such as in an amount less than about 8% by weight, such as in an amount less than about 6% by weight, such as in an amount less than about 4% by weight, such as in an amount less than about 3.5% by weight, such as in an amount less than about 3% by weight.

In addition to the melt strength modifier, the polymer composition may contain various other additives and ingredients. For example, antioxidants may include phenolic and phosphitic antioxidants which can be included to enhance the processing and end use stability of the product. For example pentaerythritol tetrakis(3-(3,5-di-tert-butyl-4-hydroxyphenyl)propionate), Tris(2,4-di-t-butylphenyl)phosphite, a catalyst neutralizer, such as metal stearates (such as calcium stearate), hydrotalcites, calcium lactate, and metal oxides; and combinations thereof can be included in the composition. In addition, the composition may contain processing aids, pigments, ultraviolet absorbers, flame retardants and lubricants.

By increasing the melt strength of the polypropylene polymer, the polymer composition of the present disclosure is well suited for applications where high melt strength is needed, such as in thermoforming processes and during foam-forming processes.

During the extrusion-thermoforming processes, for instance, the melt strength modifier is blended with one or more polypropylene polymers and heated into a molten state. For instance, the melt strength modifier can be compounded with the polypropylene polymer or can be added to the polypropylene polymer after the polymer has been heated. Once in a molten state, the polymer composition can then be formed into any suitable article.

Thus, the polymer composition of the present disclosure is particularly well suited for forming such articles. Polymer articles that can be made in accordance with the present disclosure include, for instance, articles used in food packaging, disposable articles such as drinking cups, parts of large appliances such as fridge inner liners, automotive parts such as recreational vehicle panels and the like.

In addition to forming polymer articles through thermoforming, the composition of the present disclosure is also well suited to producing foam structures. Foam structures can be made using any suitable method. In one embodiment, for instance, the polymer composition is heated to a molten state. The melt strength modifier can be directly pre-compounded with one or more polypropylene polymers or can be added to the extruder at the same time as the propylene polymers. Similarly, one or more blowing agents and/or nucleating agents that are designed to induce foam formation can also be added to the polymer composition. For instance, the blowing agent can disperse in the molten polymer composition to eventually form foam cells. The polymer composition containing the foam cells can then be molded into a desired shape in order to form a foamed article. For instance, foamed articles could be a disposable drinking cup.

As described above, in addition to a blowing agent, a nucleating agent can also be added. The nucleating agent may comprise, for instance, talc, calcium carbonate, an amide, such as a fatty acid amide, for instance, stearamide.

For instance, in one embodiment, the polymer composition of the present disclosure is heated to a molten state in a melt processing step. In one embodiment, for instance, the melt processing step can take place in an extruder. A blowing agent is contained within the polymer composition or combined with the polymer composition in the molten state. The blowing agent can comprise any suitable blowing agent capable of inducing cell formation. The blowing agent, for instance, may be a chemical blowing agent or a physical blowing agent.

The amount of blowing agent added to the polymer composition can depend on various factors including the type of foam being formed and the type of blowing agent used. In general, the blowing agent is added in an amount greater than about 0.1% by weight, such as in an amount greater than about 0.5% by weight, such as in an amount greater than about 1% by weight, such as in an amount greater than about 2% by weight, such as in an amount greater than about 5% by weight. The blowing agent is typically added to the polymer composition in an amount less than about 15% by weight, such as in an amount less than about 10% by weight, such as in an amount less than about 8% by weight, such as in an amount less than about 6% by weight, such as in an amount less than about 4% by weight.

Blowing agents (also known as foaming or expansion agents) that can be employed, including gaseous materials, volatile liquids and chemical agents which decompose into a gas and other byproducts. Representative blowing agents include, without limitation, nitrogen, carbon dioxide, isobutane, cyclopentane, air, methyl chloride, ethyl chloride, pentane, isopentane, perfluoromethane, chlorotrifluoromethane, dichlorodifluoromethane, trichlorofluoromethane, perfluoroethane, 1-chloro-1,1-difluoroethane, chloropentafluoro-ethane, dichlorotetrafluoroethane, trichlorotrifluoroethane, perfluoropropane, chlorohepta-fluoropropane, dichlorohexafluoropropane, perfluorobutane, chlorononafluorobutane, perfluorocyclobutane, azodicarbonamide (ADCA), azodiisobutyronitrile, benzenesulfon-hydrazide, 4,4-oxybenzene sulfonyl-semicarbazide, p-toluene sulfonyl semicarbazide, barium azodicarboxylate, N,N′dimethyl-N,N′-dinitrosoterephthalamide, trihydrazino triazine, N,N-dinitroso pentamethylene, citric acid derivative, tetramine, 5-phenyltetrazole, hydrazo dicarbonamide, p-toluene sulfonyl hydrazide, or mixtures thereof. The blowing agent can be used alone or in combination with one or more other blowing agents.

Once the blowing agent is combined and the polymer composition is heated, in one embodiment, the molten polymer composition can be extruded and formed into a desired shape.

Of particular advantage, the polymer composition of the present disclosure can be thermoformed into any suitable shape or formed into a foam structure without having to use a polypropylene polymer having long chain branches. For instance, the polypropylene polymer used in the present disclosure can be linear and can have a relatively low amount of branching, such as <0.001 LCB per 1000 C.

The present disclosure may be better understood with reference to the following examples.

### EXAMPLES

Various different polymer compositions were formulated and tested for melt strength.

Sample 3, 4 and 5

A polypropylene homopolymer with the defined MFR, weight percent (wt) of xylene solubles and polydispersity index were premixed with the melt strength modifier in 0.8, 1 and 2 wt % and additional antioxidants and acid scavenger and compounded in a twin screw extruder to form pellets.

Samples 1 and 2 Comparative

A polypropylene homopolymer powders used to prepare samples 3, 4 and 5 were mixed following the same method was used to prepare sample 3, 4 and 5 with exception that no melt strength modifier was used.

Sample 6 is a homopolymer that contains long chain branching in levels approximately of 0.2 LCB/1000 C and which contained no melt strength modifier.

Melt flow rate (MFR) was measured in accordance with the ASTM-D 1238 test method at 230° C. with a 2.16 kg weight.

Xylene solubles were measured following ASTM-D5492.

In particular, the following samples were prepared:

TABLE NO. 1

| Sample | MFR | XS | PDI | Specification |
|---|---|---|---|---|
| 1 | 2.3 | 6.8 | 5.8 | |
| 2 | 2.3 | 2.6 | 3.9 | |
| 3 | 2.4 | 6.7 | 5.8 | 1 wt % sorbitol derivative |
| 4 | 2.5 | 6.7 | 5.8 | 2 wt % sorbitol derivative |
| 5 | 2.4 | 2.6 | 3.9 | 0.8 wt % sorbitol derivative |
| 6 | 1.9 | 3.6 | — | ~0.2 LCB/1000 C |

The above formulations were then tested according to the tests defined above. First, the polymer compositions were tested for shear thinning factor (STF). The following results were obtained:

TABLE NO. 2

| | | | V-E | | |
|---|---|---|---|---|---|
| | Zero shear | | Transition | | |
| Sample | viscosity | SHI | Temperature | STF | Elasticity Index |
| CE1 | 43033 | 0.39 | No transition | 86 | 0.11 |
| CE2 | 25518 | 0.31 | No transition | 35 | 0.05 |
| 3 | 2E9 | 1.27 | 230 | 4.7E4 | 0.55 |
| 4 | 1.2E6 | 1.47 | — | 264 | 0.33 |
| 5 | 1.8E7 | 1.31 | 220 | 1683 | 0.47 |
| CE6 | 3.3E6 | 3.0 | No transition | 3.8E4 | 0.50 |

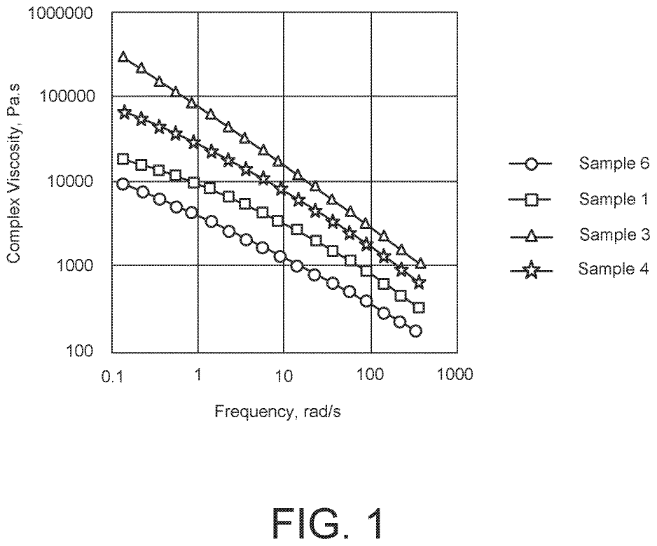

Referring to FIG. 1, the oscillatory rheology of the samples tested is illustrated.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A polymer composition with increased melt strength comprising:
a polypropylene polymer blended with a melt strength modifier, the melt strength modifier being present in the polymer composition in an amount sufficient to create a penetration network when the polymer composition is heated to a molten state.

2. A polymer composition as defined in claim 1, wherein the polymer composition comprises at least 90% by weight polypropylene polymer.

3. A polymer composition as defined in claim 1, wherein the polymer composition has a viscoelastic transition temperature of at least 180° C.

4. A polymer composition as defined in claim 1, wherein the polymer composition has a strain hardening index of greater than 0.4, a shear thinning factor of greater than 100, and an elastic index of greater than 0.2.

5. A polymer composition as defined in claim 1, wherein the polypropylene polymer comprises a polypropylene homopolymer.

6. A polymer composition as defined in claim 1, wherein the polypropylene polymer comprises a polypropylene copolymer,

7. A polymer composition as defined in claim 1, wherein the melt strength modifier comprises a benzylidiene sorbitol derivative.

8. A polymer composition as defined in claim 1, wherein the polymer composition has a strain hardening index of greater than about 0.9.

9. A polymer composition as defined in claim 1, wherein the polymer composition has a shear thinning factor of greater than about 120.

10. A polymer composition as defined in claim 1, wherein the polymer composition has a viscosity transition temperature of from about 190° C. to about 230° C.

11. A polymer composition as defined in claim 1, wherein the polymer composition has an elastic index of greater than about 0.4.

12. A polymer composition as defined in claim 1, wherein the melt strength modifier comprises 1,3:2,4-bis(3,4-dimethyldibenzylidene)sorbitol, 1,2,3-tridesoxy-4,6:5,7-bis-O-[(4-propylphenyl)methylene]nonitol, 1,3:2,4-bis(p-nitrobenzylidene)sorbitol, (1,3-2,4-dibenzylidenesorbitol), 1,3-2,4-bis(p-methoxybenzylidene)sorbitol, 1,3:2,4-bis(m-methoxybenzylidene)sorbitol, 1,3:2,4-bis(p-chlorobenzylidene)sorbitol, 1,3:2,4-bis(p-methylbenzylidene)sorbitol, or mixtures thereof.

13. A polymer composition as defined in claim 1, wherein the melt strength modifier is present in the polymer composition in an amount from about 0.6% to about 10% by weight.

14. A polymer composition as defined in claim 1, wherein the polypropylene polymer has a branching index of less than about 0.001.

15. A polymer composition as defined in claim 1, wherein the polymer composition further contains a foam forming inducing nucleating agent in addition to the melt strength modifier.

16. A polymer composition as defined in claim 1, wherein the polymer composition contains a blowing agent.

17. A polymer composition as defined in claim 16, wherein the blowing agent comprises nitrogen, carbon dioxide, isobutane, cyclopentane, air, methyl chloride, ethyl chloride, pentane, isopentane, perfluoromethane, chlorotrifluoromethane, dichlorodifluoromethane, trichlorofluoromethane, perfluoroethane, 1-chloro-1,1-difluoroethane, chloropentafluoro-ethane, dichlorotetrafluoroethane, trichlorotrifluoroethane, perfluoropropane, chlorohepta-fluoropropane, dichlorohexafluoropropane, perfluorobutane, chlorononafluorobutane, perfluorocyclobutane, azodicarbonamide (ADCA), azodiisobutyronitrile, benzenesulfon-hydrazide, 4,4-oxybenzene sulfonyl-semicarbazide, p-toluene sulfonyl semicarbazide, barium azodicarboxylate, N,N′dimethyl-N,N′-dinitrosoterephthalamide, trihydrazino triazine, N,N-dinitroso pentamethylene, citric acid derivative, tetramine, 5-phenyltetrazole, hydrazo dicarbonamide, p-toluene sulfonyl hydrazide, or mixtures thereof.

18. A polymer composition as defined in claim 1, wherein the polymer composition has a strain hardening index of greater than about 0.9, has a shear thinning factor of greater than about 50, has a viscosity transition temperature of from about 180° C. to about 230° C., and has an elastic index of greater than about 0.2.

19. An article made from a polymer composition as defined in claim 1.

20. A process for forming a polypropylene foam comprising:
combining the polymer composition of claim 1 with a blowing agent and a nucleating agent; and
heating the polypropylene composition to a molten state sufficient for the blowing agent to induce the formation of foam cells.

21. A process as defined in claim 20, wherein the blowing agent comprises nitrogen, carbon dioxide, isobutane, cyclopentane, air, methyl chloride, ethyl chloride, pentane, isopentane, perfluoromethane, chlorotrifluoromethane, dichlorodifluoromethane, trichlorofluoromethane, perfluoroethane, 1-chloro-1,1-difluoroethane, chloropentafluoro-ethane, dichlorotetrafluoroethane, trichlorotrifluoroethane, perfluoropropane, chlorohepta-fluoropropane, dichlorohexafluoropropane, perfluorobutane, chlorononafluorobutane, perfluorocyclobutane, azodicarbonamide (ADCA), azodiisobutyronitrile, benzenesulfon-hydrazide, 4,4-oxybenzene sulfonyl-semicarbazide, p-toluene sulfonyl semicarbazide, barium azodicarboxylate, N,N′dimethyl-N,N′-dinitrosoterephthalamide, trihydrazino triazine, N,N-dinitroso pentamethylene, citric acid derivative, tetramine, 5-phenyltetrazole, hydrazo dicarbonamide, p-toluene sulfonyl hydrazide, or mixtures thereof.

22. A process as defined in claim 20, wherein the polypropylene composition is heated to a molten state prior to being combined with the blowing agent.

23. A process for thermoforming a polypropylene polymer composition comprising:
heating the polymer composition as defined in claim 1 into a molten state; and
forming the heated polymer composition into a molded article.

24. A method for increasing the melt strength of a polypropylene polymer comprising:
blending with a polypropylene polymer a melt strength modifier to form a polymer composition, the melt strength modifier being present in the polymer composition in an amount sufficient for the polymer composition to have a strain hardening index of greater than about 0.4 and a shear thinning factor of greater than about 100, an elastic index of greater than 0.2 and a viscoelastic transition temperature of greater than 180° C.
